(19) United States
(12) Patent Application Publication
(10) Pub. No.: US 2020/0342302 A1
(43) Pub. Date: Oct. 29, 2020

(54) COGNITIVE FORECASTING

(71) Applicant: ACCENTURE GLOBAL SOLUTIONS LIMITED, Dublin (IE)

(72) Inventors: Priyanka PRATIHAR, Kolkata (IN); Vinu VARGHESE, Bangalore (IN); Anil KUMAR, Bangalore (IN); Soundar RAJAN, Bangalore (IN); Mukund KUMAR, Bangalore (IN); Saran PRASAD, New Delhi (IN); Nirav SAMPAT, Mumbai (IN)

(73) Assignee: ACCENTURE GLOBAL SOLUTIONS LIMITED, Dublin (IE)

(21) Appl. No.: 16/393,506

(22) Filed: Apr. 24, 2019

(51) Int. Cl. G06N 3/08; G06N 20/00; G06Q 10/04; G06F 16/9032

(52) U.S. Cl. CPC G06N 3/08; G06F 16/9032; G06Q 10/04; G06N 20/00

(57) ABSTRACT

Examples of a cognitive forecasting system are defined. In an example, the system receives a forecasting requirement from a user. The system obtains parameter data from a plurality of data sources associated with the forecasting requirement and identify a parameter set therein. The system implements an artificial intelligence component to sort the parameter data into a plurality of data domains and identify a set of preponderant data domains therein. The system may update the preponderant data domains based on a modification in the plurality of data domains. The system may establish a forecasting model corresponding to the forecasting requirement by performing a cognitive learning. The system may update the forecasting model corresponding to the update in the parameter data. The system may generate a forecasting result corresponding to the forecasting requirement. The system may generate the cognitive forecasting model that may account for real time fluctuations in the data.

### BACKGROUND

Forecasting as a key organizational process has grown in importance in recent times. For example, forecasting has become an indispensable decision-making tool for most industrial and organizational operations. An accurate forecast regarding a future acquisition may lead to a systematic attempt in understanding future performance. Indeed, an organization may become better equipped for making informed decisions and become more resistant to unforeseen requirements if it uses appropriate forecasting models. Historically, models such as, for example, a root cause analysis model have been deployed for forecasting, wherein a series of data is identified and may be analyzed to generate a forecast. Such methods often generate an outcome, which may be devoid of a specific forecasting interference.

Currently, the forecasting process uses a series of data and applies various analytical tools on the data. However, such a forecasting technique has a high probability of missing various key factors. For example, each of the analytical tools applied to the series of data may suppress any outlier data for the purpose of analysis, thereby leading to a high probability of missing critical information and generating an inaccurate forecasted conclusion. Additionally, current forecasting process may involve forecasting models based on artificial intelligence with historical data sets. Such methods suffer from inaccuracy as historical data, which forms the basis for such methods, may change at any time, thereby nullifying any forecasted inference generated thus far. Furthermore, such methods may not consider real-time factors while generating forecasting interferences. Additionally, organizations have been becoming an “always on” environment, thereby making the process of forecasting quite difficult and inaccurate using such methods. Using current forecasting techniques, which are driven by historical data may constrain the efficiency of the forecasting processes because such processes may be not be optimized in the world of “always on” where the market landscape, technology disruption, and demand situation constantly evolve.

There is therefore a need for using techniques for forecasting, which may consider diverse factors relevant for a particular process and industry. Additionally, real-time fluctuations and impact ratio may have a huge impact in the forecasting, and therefore should be considered for any forecasting process.

There is a requirement for a forecasting model, which may consider future factors, and complex organizational scenarios along with taking into account real-time factors for the generation of specific forecasting details, thereby assisting with real-time investments and decisions. There is also a requirement for a forecasting model, which may be evolving continuously based on a changing data paradigm. In addition, organizations may need to reactively synthesize forecasting intelligence in order to account for the impact of future factors based on the request of a user

Accordingly, a technical problem with the currently available procurement processes is that they may be inefficient, inaccurate, and/or not scalable. There is a need for an intelligence forecasting system which will consider the appropriate set of criteria, real-time fluctuations, and impact of the criteria in a decision making process. The system may be required to constantly sense emerging risks and opportunities, the evaluation of recommendations, and the rapid action/engagement opportunities to forecast the best possible outcomes.

### BRIEF DESCRIPTION OF DRAWINGS

FIG. 1 illustrates a diagram for a system for a cognitive forecasting model, according to an example embodiment of the present disclosure.

FIG. 2 illustrates various components of the system for a cognitive forecasting model, according to an example embodiment of the present disclosure.

FIG. 3 illustrates example areas of a cognitive forecasting model, according to an example embodiment of the present disclosure.

FIG. 4 illustrates a process flowchart for generating a forecast based on a cognitive forecasting model, according to an example embodiment of the present disclosure.

FIG. 5 illustrates a process flowchart including algorithmic details for a cognitive forecasting model, according to an example embodiment of the present disclosure.

FIG. 6 illustrates a process flowchart for a use case for a cognitive forecasting model, according to an example embodiment of the present disclosure.

FIG. 7 illustrates a process flowchart for an alternate use case for cognitive forecasting model, according to an example embodiment of the present disclosure.

FIG. 8 illustrates a hardware platform for implementation of the system, according to an example embodiment of the present disclosure.

FIGS. 9A and 9B illustrate a process flowchart for a cognitive forecasting model, according to an example embodiment of the present disclosure.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “an” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to.

The present disclosure describes a system and method for a cognitive forecasting model system (CFM). The cognitive forecasting model system (referred to as “system”) may be used to forecast a variety of factors critical to a process, industry, or organization. For example, the system may be used to forecast changes in a retail sector operation, changes in media viewing habits of a user, and availability of workers for a project that may require a particular skill set amongst others. The system may account for real-time fluctuations in data and, analyze any outlier data as well to provide a more accurate forecast.

The system may include a processor, a data assembler, an updater, and a modeler. The processor may be coupled to the data assembler, the updater, and the modeler. The data assembler may be configured to receive a query from a user. The query may indicate a forecasting requirement associated with at least one of a process, an organization, and an industry relevant for operations. The data assembler may obtain parameter data from a plurality of data sources associated with the forecasting requirement and identify a parameter set from the parameter data to process the forecasting requirement. The data assembler may implement an artificial intelligence component to sort the parameter data into a plurality of data domains. The data assembler may evaluate each domain from the plurality of data domains of the parameter data to identify preponderant data domains. The preponderant data domains may be data domains from the plurality of data domains, which might have a greater prevalence of other domains from the plurality of data domains for processing the forecasting requirement. In an example, the data assembler may establish a forecast library, by associating the preponderant data domains and the identified parameter set with the forecasting requirement. In an example, the data assembler may update the parameter data simultaneously as it is acquired by the plurality of data sources, thereby making the system a forecasting model based upon real-time data.

The updater may determine whether the preponderant data domains may need to be updated based on a modification in the plurality of data domains and a modification in the identified parameter set. In an example, the modification in the plurality of data domains may be due to a fluctuation in a data set from any of the plurality of data domains. In an example, the modification in the identified parameter set may be due to fluctuation in any of the preponderant data domains. The updater may update the preponderant data domains based on the modification in the plurality of data domains and the modification in the identified parameter set. In an example, the updater may electronically notify the user when there may be a change in the preponderant data domains due to the modification in the plurality of data domains and the modification in the identified parameter set.

The modeler may obtain the updated preponderant data domains identified from the plurality of data domains. The modeler may obtain the identified parameter set from the processor. The modeler may establish a forecasting model corresponding to the forecasting requirement associated with the query by performing a cognitive learning operation on a domain from the updated preponderant data domains and the identified parameter set. The modeler may update the forecasting model corresponding to the update in the updated preponderant data domains. The modeler may generate a forecasting result corresponding to the forecasting requirement, the forecasting result comprising the forecasting model relevant for a resolution to the query. In an example, the forecasting result may be generated as an electronic document in response to the query of the user. In an example, the modeler may provide evidence supporting the forecasting model.

The embodiments for the forecasting requirements presented herein are exemplary in nature and should be treated as such. For the sake of brevity and technical clarity, the description of the cognitive forecasting model may be restricted to few exemplary embodiments, however, to a person skilled in the art it should be clear that the cognitive sourcing model (system) may be used for fulfillment of various forecasting requirements other than those mentioned hereinafter.

Accordingly, the present disclosure aims to provide a real intelligence forecasting model which will consider the right set of criteria, real-time fluctuations and impact of the criteria in that particular decision and outcome of forecasting. The model may be required to constantly sense emerging risks and opportunities, the evaluation of recommendations, and the rapid action/engagement opportunities to forecast. The system may provide for the best outcome of a forecasting process and facilitates in making the tedious task of compiling forecasting intelligence more effective. The present disclosure provides for efficient and continuous analysis of data required for various forecasting processes for organizational intelligence operations, which in turn provides for continuous, efficient and accurate analysis of the forecasting requirements of a user. The system may be configured to support human decision making for processing a forecasting requirement. Furthermore, the system may then analyze various categories of forecasting data, based on the various parameters to accurately interpret the transactional documents. Because system may capture all relevant elements (processes and/or features) of a problem and the subsequent analysis of the problem may be performed based on forecasting models corresponding to the elements, the analysis may be substantially free from errors.

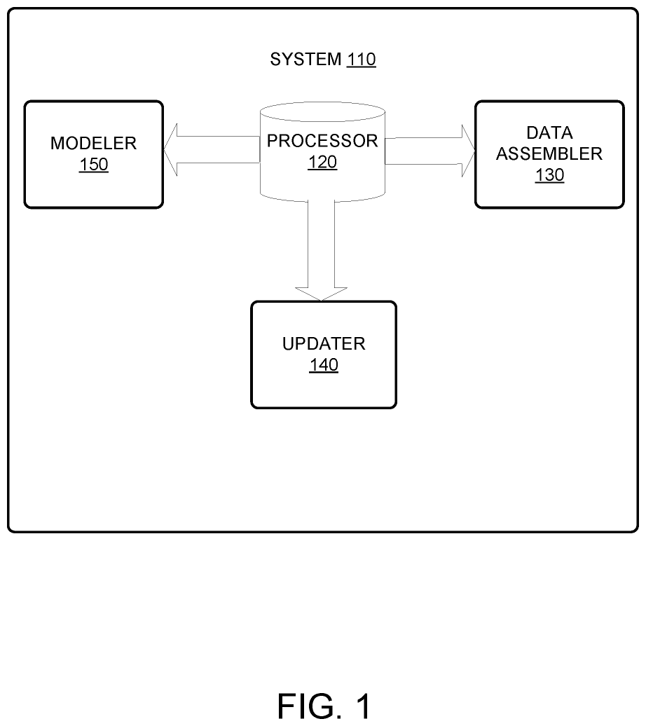

FIG. 1 illustrates a system for cognitive forecasting model 110 (referred to as system 110 hereinafter), according to an example implementation of the present disclosure. In an example, the system 110 may include a processor 120. The processor 120 may be coupled to a data assembler 130, an updater 140 and a modeler 150.

In accordance with an embodiment of the present disclosure, the data assembler 130 may be configured to receive a query from a user. The query may indicate a forecasting requirement associated with at least one of a process, an organization, and an industry relevant for operations. In an example, the forecasting requirement may indicate a requirement, which may refer to a purpose of forecasting. For example, the purpose may be to access recruitment in an organization for projects in the next 5 years. The purpose of the forecasting may be to understand the different courses which need to be introduced in an organization for the training of human resources for an organization. The purpose of the forecasting may be a selection of digital entertainment platform to invest in a series for a service provider. The purpose of the forecasting may be to know the next set of sales values of mobiles for a manufacturing organization. The embodiments for the forecasting requirements presented herein are exemplary in nature and should be treated as such. For the sake of brevity and technical clarity, the description of the cognitive forecasting model may be restricted to few exemplary embodiments, however, to a person skilled in the art it should be clear that the cognitive sourcing model (system 110) may be used for fulfillment of various forecasting requirements other than those mentioned hereinafter.

The data assembler 130 may obtain parameter data from a plurality of data sources associated with the forecasting requirement and identify a parameter set from the parameter data to process the forecasting requirement. In an example, the parameter data further comprise researching various factors like features of a product or service, benefits of a product or service, cost of a product or service, availability of a product or service, location of a product or service, delivery method of a product or service, information regarding updates in a product or service, innovation assessment for a product or service, risk assessment for a product or service, technology assessment for a product or service, an existing collaboration for a product or service and the like. In an example, the parameter data may be a set of historical data stored in the system 110, which may be accessed by the system 110 for processing the forecasting requirement. In accordance with an embodiment of the present disclosure, the plurality of data sources may include various databases across Internet, news articles, various databases maintained by various external organizations, various internal databases comprising historical data that may be maintained by an organization.

As mentioned above, the data assembler 130 may identify the parameter set from the parameter data to process the forecasting requirement. The parameter set may include a measurable factor, which may form one of a set that may define a condition for processing the forecasting requirement. In an example, the parameter set may include multiple measurable factors that would have an impact on the purpose of the forecasting requirement. For example, the purpose of the forecasting may be to understand the different courses which need to be introduced in an organization for the training of human resources for an organization. The data assembler 130 may search through the plurality of data sources and identify measurable factors, which may have an impact on the requirement of various courses. For example, the data assembler 130 may identify different skills which may be in the market and may be serving the different domains and industries through searching various databases over the Internet. The data assembler 130 may access the historical data stored in the system 110 for identifying various categories, which may be used for classification of various courses as per an organizational requirement. The data assembler 130 may identify an uptick in the popularity of a certain skill or trend for an industry. The data assembler 130 may research different content providers for skills, and training which may help the organization to auto scale and upscale the human resources and make relevant to industry and serve the needs of the market. Further, the data assembler 130 may identify other measurable factors (not mentioned herein), which may be relevant for the processing the forecasting requirement of understanding various training courses for an organization (explained further in detail with more exemplary embodiments by way of subsequent FIGS.).

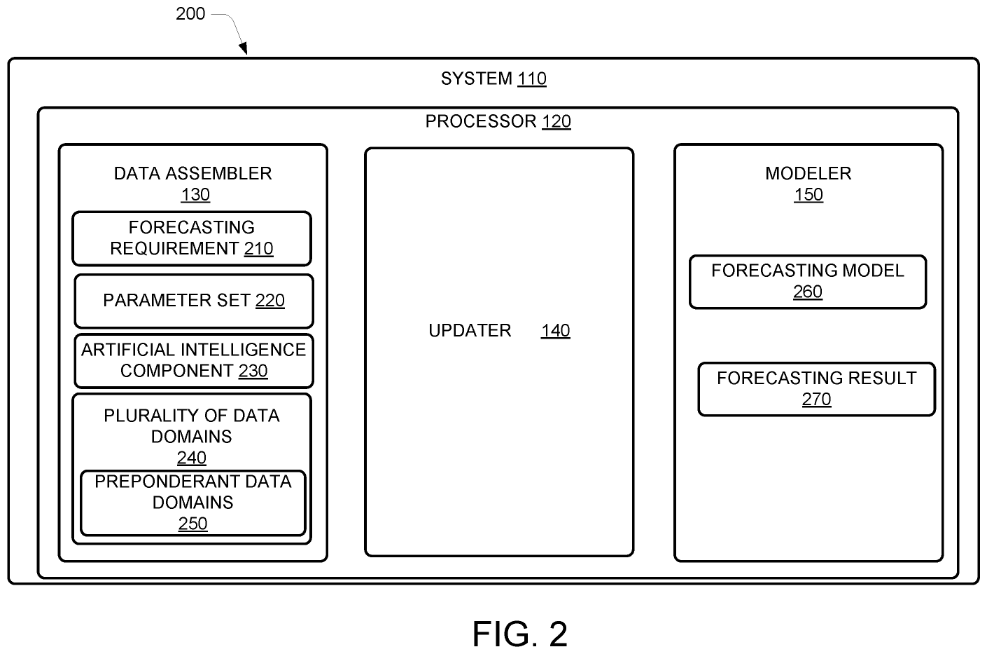

The data assembler 130 may implement an artificial intelligence component to sort the parameter data into a plurality of data domains. The artificial intelligence component may be one of a data extractor, a data classifier, a data associator, a data comparer, a relationship extractor, and a dependency parser and the like. The plurality of data domains (further explained by way of FIG. 2). In an example, the parameter set may be identified through application of a set of category intelligence operations on at least one domain from the plurality of data domains. The category intelligence operations may include identification of all measurable factors associated with the purpose of the forecasting requirement (further explained by way of subsequent FIGS.). In an example, the system 110 may identify a new parameter set for processing each forecasting requirement. In an example, the parameter set identified for a forecasting requirement may include at least one set that has been pre-set by a user.

The data assembler 130 may evaluate each domain from the plurality of data domains of the parameter data to identify preponderant data domains. The preponderant data domains may be data domains from the plurality of data domains, that may have a greater prevalence of other domains from the plurality of data domains for processing the forecasting requirement. In an example, the preponderant data domains may be domains which may be classified by the data assembler 130 as being most important for processing the forecasting requirement. As mentioned above, the system 110 may analyze a variety of factors critical to a process, industry, or organization, and may also analyze outlier data for processing the forecasting requirement. Accordingly, the system 110 may identify at least one domain from the plurality of data domains as being preponderant data domain for the forecasting requirement (explained in detail by way of subsequent FIGS. along with exemplary embodiments). In an example, the preponderant data domains may be one of the outlier data sets. In an example, the preponderant data domains may be those pertaining to financial considerations while processing the forecasting requirements. In an example, the system 110 may identify a new set of the preponderant data domains for processing each forecasting requirement. In an example, the preponderant data domains identified for a forecasting requirement may include at least one domain that has been pre-set by a user.

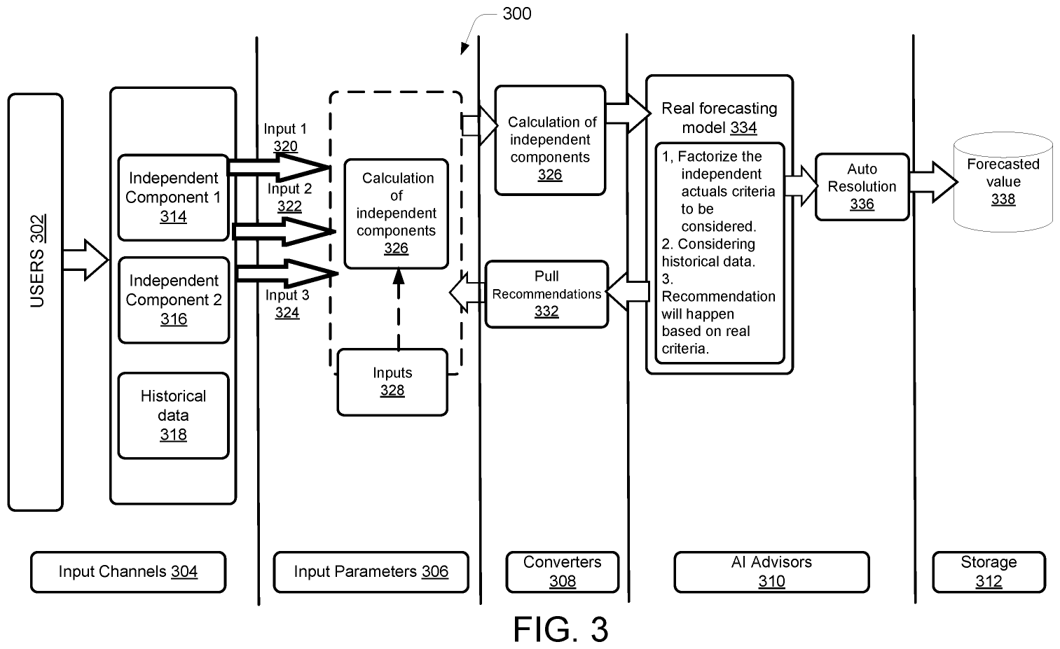

In an example, data assembler 130 may establish a forecast library, by associating the preponderant data domains and the identified parameter set with the forecasting requirement. For example, the system 110 may identify a parameter set for a particular forecasting requirement. Additionally, the system would also identify a set of preponderant data domains for that particular forecasting requirement. The data assembler 130 may be configured to associate the identified parameter set and the identified preponderant data domains for that specific forecasting requirement. The system 110 may store the identified parameter set with the associated preponderant data domains in the forecast library. The system 110 may access the forecast library for using the identified parameter set with the associated preponderant data domains for processing a similar forecasting requirement in future (further explained by way of FIG. 2 and FIG. 3).

In an example, the data assembler 130 may update the parameter data simultaneously as it is acquired by the plurality of data sources, thereby making the system 110 a forecasting model based upon real-time data. The real-time-data may refer to data that is presented as it is acquired. The data assembler 130 may receive parameter data from the plurality of data sources. The data presented by the plurality of data sources may be updated continuously, and such an update may be critical for processing a forecasting requirement in some cases. The data assembler 130 may be configured to acquire any update in parameter data pertaining to a specific forecasting requirement from the plurality of data sources on a real-time basis. Such an acquisition facilitates more effective processing of the forecasting requirement (explained further by subsequent sections).

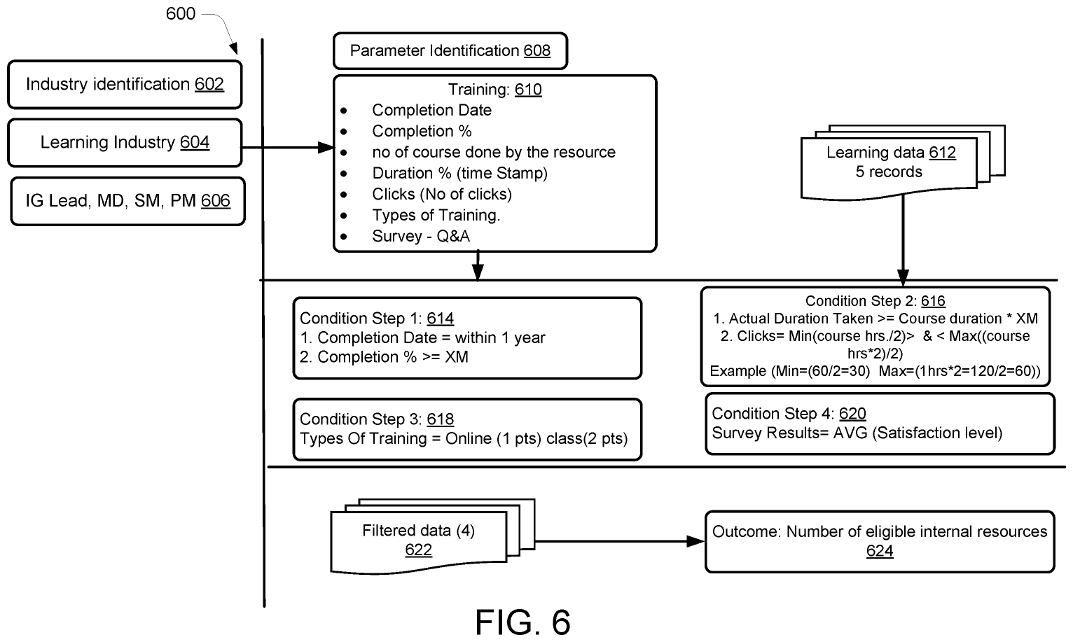

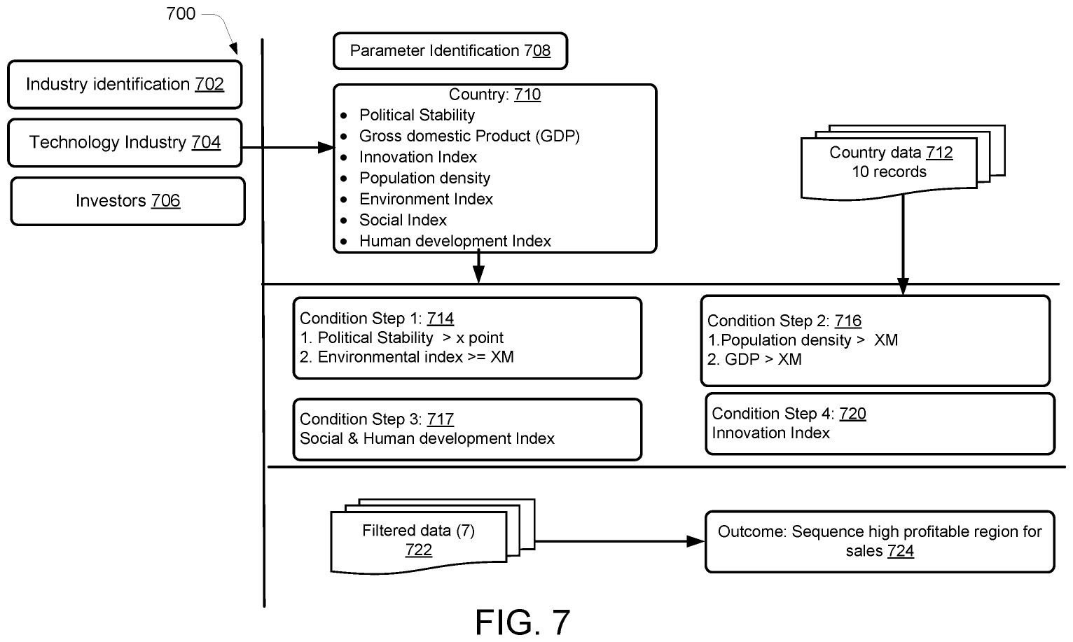

The updater 140 may determine whether the preponderant data domains may need to be updated based on a modification in the plurality of data domains and a modification in the identified parameter set. In an example, the modification in the plurality of data domains may be due to a fluctuation in a data-set from any of the plurality of data domains. In an example, the modification in the identified parameter set may be due to fluctuation in any of the preponderant data domains. The updater 140 may update the preponderant data domains based on the modification in the plurality of data domains and the modification in the identified parameter set. For example, one of the parameter data received may pertain to sales data for a particular region. There may be an update of a natural calamity occurring in that region. Such an update would be acquired by the data assembler 130 and the preponderant data domains, and the identified parameter set would be updated to include the possibility of the natural disaster. In another example, there may be an update in information on a political or strategic parameter associated with a forecasting requirement. Such an update would be acquired by the data assembler 130 and the preponderant data domains, and the identified parameter set would be updated accordingly (explained further by way of FIG. 6 and FIG. 7). In an example, the updater 140 may electronically notify the user when there may be a change in the preponderant data domains due to the modification in the plurality of data domains and the modification in the identified parameter set. As mentioned above, in some cases the updates in the parameter data received from the plurality of sources may have a critical impact on the processing of the forecasting requirement. In some cases, the preponderant data domains may require an update based on new information available through the parameter data. The system 110 may be configured to notify the user whenever an update available for parameter data being monitored for processing the forecasting requirement leads to a change in the preponderant data domains. In an example, the system 110 may require permission from the user for updating the preponderant data domains based on new information available through the parameter data.

The modeler 150 may obtain the updated preponderant data domains identified from the plurality of data domains. The modeler 150 may obtain the identified parameter set from the processor. The modeler 150 may establish a forecasting model corresponding to the forecasting requirement associated with the query by performing a cognitive learning operation on a domain from the updated preponderant data domains and the identified parameter set (explained in detail by way of FIGS. 2 to 8).

The modeler 150 may update the forecasting model corresponding to the update in the updated preponderant data domains. For example, one of the parameter data received may pertain to sales data for a particular region. There may be an update of a natural calamity occurring in that region. Such an update would be acquired by the data assembler 130 and the preponderant data domains, and the identified parameter set would be updated to include the possibility of the natural disaster. The forecasting model generated thus far may need to be updated to incorporate the impact of the natural disaster as well. The system 110 may be configured to update the forecasting model whenever there may be an update in the preponderant data domains.

The modeler 150 may generate a forecasting result corresponding to the forecasting requirement. The forecasting result may include the forecasting model relevant for a resolution to the query associated with the forecasting requirement. In an example, the forecasting result may be generated as an electronic document in response to the query of the user. In an example, the modeler 150 may provide evidence supporting the forecasting model.

FIG. 2 illustrates various components of the system 110 for cognitive forecasting model, according to an example embodiment of the present disclosure.

In accordance with an example of the present disclosure, the system 110 described herein may include the processor 120. The processor 120 may be coupled to the data assembler 130, the updater 140 and the modeler 150.

In accordance with an embodiment of the present disclosure, the data assembler 130 may be configured to receive a query from a user. The query may indicate a forecasting requirement 210 (also referred to as “forecasting requirements 210”) associated with at least one of a process, an organization, and an industry relevant for operations. In an example, the forecasting requirement 210 may indicate a requirement, which may refer to the purpose of forecasting. For example, the purpose may be to access recruitment in an organization for projects in the next 5 years. The purpose of the forecasting may be to understand the different courses which need to be introduced in an organization for the training of human resources for an organization. The purpose of the forecasting may be a selection of digital entertainment platform to invest in a series for a service provider. The purpose of the forecasting may be to know a next set of sales values of mobiles for a manufacturing organization. The embodiments for the forecasting requirements 210 presented herein are exemplary in nature and should be treated as such. For the sake of brevity and technical clarity, the description of the cognitive forecasting model may be restricted to few exemplary embodiments, however, to a person skilled in art it should be clear that the cognitive sourcing model (system 110) may be used for fulfillment of various forecasting requirements 210 other than those mentioned hereinafter.

The data assembler 130 may obtain parameter data from a plurality of data sources associated with the forecasting requirement 210 and identify a parameter set 220 from the parameter data to process the forecasting requirement 210. In an example, the parameter data further comprise researching various factors like features of a product or service, benefits of a product or service, cost of a product or service, availability of a product or service, location of a product or service, delivery method of a product or service, information regarding updates in a product or service, innovation assessment for a product or service, risk assessment for a product or service, technology assessment for a product or service, an existing collaboration for a product or service and the like. In an example, the parameter data may be a set of historical data stored in the system 110, which may be accessed by the system 110 for processing the forecasting requirement 210. In accordance with an embodiment of the present disclosure, the plurality of data sources may include various databases across Internet, news articles, various databases maintained by various external organizations, various internal databases comprising historical data that may be maintained by an organization.

As mentioned above, the data assembler 130 may identify the parameter set 220 from the parameter data to process the forecasting requirement 210. The parameter set 220 may include a measurable factor, which may be forming one of a set that may define a condition for processing the forecasting requirement 210. In an example, the parameter set 220 may include multiple measurable factors that would have an impact on the purpose of the forecasting requirement 210. For example, the purpose of the forecasting may be to understand the different courses which need to be introduced in an organization for the training of human resources for an organization. The data assembler 130 may search through the plurality of data sources and identify measurable factors, which may have an impact on the requirement of various courses. For example, the data assembler 130 may identify different skills which may be in the market and may be serving the different domains and industries through searching various databases over the Internet. The data assembler 130 may access the historical data stored in the system 110 for identifying various categories, which may be used for classification of various courses as per an organizational requirement. The data assembler 130 may identify an uptick in the popularity of a certain skill or trend for an industry. The data assembler 130 may research different content providers for skills, and training which may help the organization to auto scale and upscale the human resources and make relevant to industry and serve the needs of the market. Further, the data assembler 130 may identify other measurable factors (not mentioned herein), which may be relevant for the processing the forecasting requirement 210 of understanding various training courses for an organization (explained further in detail with more exemplary embodiments by way of subsequent FIGS.).

The data assembler 130 may implement an artificial intelligence component 230 to sort the parameter data into a plurality of data domains 240. The artificial intelligence component 230 may be one of a data extractor, a data classifier, a data associator, a data comparer, a relationship extractor, and a dependency parser and the like. In an example, the parameter set 220 may be identified through application of a set of category intelligence operations on at least one domain from the plurality of data domains 240. The category intelligence operations may include identification of all measurable factors associated with the purpose of the forecasting requirement 210 (further explained by way of subsequent FIGS.). In an example, the system 110 may identify a new parameter set 220 for processing each forecasting requirement 210. In an example, the parameter set 220 identified for a forecasting requirement 210 may include at least one set that has been pre-set by a user.

The data assembler 130 may evaluate each domain from the plurality of data domains 240 of the parameter data to identify preponderant data domains 250. The preponderant data domains 250 may be data domains from the plurality of data domains 240, which might have a greater prevalence of other domains from the plurality of data domains 240 for processing the forecasting requirement 210. In an example, the preponderant data domains 250 may be domains which may be classified by the data assembler 130 as being most important for processing the forecasting requirement 210. As mentioned above, the system 110 may analyze a variety of factors critical to a process, industry, or organization and may also analyze outlier data for processing the forecasting requirement 210. Accordingly, the system 110 may identify at least one domain from the plurality of data domains 240 as being preponderant data domain for the forecasting requirement 210 (explained in detail by way of subsequent FIGS. along with exemplary embodiments). In an example, the preponderant data domains 250 may be one of the outlier data sets. In an example, the preponderant data domains 250 may be those pertaining to financial considerations while processing the forecasting requirements 210. In an example, the system 110 may identify a new set of the preponderant data domains 250 for processing each forecasting requirement 210. In an example, the preponderant data domains 250 identified for a forecasting requirement 210 may include at least one domain that has been pre-set by a user.

In an example, data assembler 130 may establish a forecast library, by associating the preponderant data domains 250 and the identified parameter set 220 with the forecasting requirement 210. For example, the system 110 may identify a parameter set 220 for a particular forecasting requirement 210. Additionally, the system 110 would also identify a set of preponderant data domains 250 for that particular forecasting requirement 210. The data assembler 130 may be configured to associate the identified parameter set 220 and the identified preponderant data domains 250 for that specific forecasting requirement 210. The system 110 may store the identified parameter set 220 with the associated preponderant data domains 250 in the forecast library. The system 110 may access the forecast library for using the identified parameter set 220 with the associated preponderant data domains 250 for processing a similar forecasting requirement 210 in future (further explained by way of FIG. 2 and FIG. 3).

In an example, the data assembler 130 may update the parameter data simultaneously as it is acquired by the plurality of data sources, thereby making the system 110 a forecasting model based upon real-time data. The real-time-data may refer to data that is presented as it is acquired. The data assembler 130 may receive parameter data from the plurality of data sources. The data presented by the plurality of data sources may be updated continuously, and such an update may be critical for processing a forecasting requirement 210 in some cases. The data assembler 130 may be configured to acquire any update in parameter data pertaining to a specific forecasting requirement 210 from the plurality of data sources on a real-time basis. Such an acquisition facilitates more effective processing of the forecasting requirement 210 (explained further by subsequent sections).

The updater 140 may determine whether the preponderant data domains 250 may need to be updated based on a modification in the plurality of data domains 240 and a modification in the identified parameter set 220. In an example, the modification in the plurality of data domains 240 may be due to a fluctuation in a data-set from any of the plurality of data domains 240. In an example, the modification in the identified parameter set 220 may be due to fluctuation in any of the preponderant data domains 250. The updater 140 may update the preponderant data domains 250 based on the modification in the plurality of data domains 240 and the modification in the identified parameter set 220. For example, one of the parameter data received may pertain to sales data for a particular region. There may be an update of a natural calamity occurring in that region. Such an update would be acquired by the data assembler 130 and the preponderant data domains 250, and the identified parameter set 220 would be updated to include the possibility of the natural disaster. In another example, there may be an update in information on a political or strategic parameter associated with a forecasting requirement 210. Such an update would be acquired by the data assembler 130 and the preponderant data domains 250, and the identified parameter set 220 would be updated accordingly (explained further by way of FIG. 6 and FIG. 7). In an example, the updater 140 may electronically notify the user when there may be a change in the preponderant data domains 250 due to the modification in the plurality of data domains 240 and the modification in the identified parameter set 220. As mentioned above, in some cases the updates in the parameter data received from the plurality of sources may have a critical impact on the processing of the forecasting requirement 210. In some cases, the preponderant data domains 250 may require an update based on new information available through the parameter data. The system 110 may be configured to notify the user whenever an update available for parameter data being monitored for processing the forecasting requirement 210 leads to a change in the preponderant data domains 250. In an example, the system 110 may require permission from the user for updating the preponderant data domains 250 based on new information available through the parameter data.

The modeler 150 may obtain the updated preponderant data domains 250 identified from the plurality of data domains 240. The modeler 150 may obtain the identified parameter set 220 from the processor. The modeler 150 may establish a forecasting model 260 corresponding to the forecasting requirement 210 associated with the query by performing a cognitive learning operation on a domain from the updated preponderant data domains 250 and the identified parameter set 220 (explained in detail by way of FIGS. 2 to 8).

The modeler 150 may update the forecasting model 260 corresponding to the update in the updated preponderant data domains 250. For example, one of the parameter data received may pertain to sales data for a particular region. There may be an update of a natural calamity occurring in that region. Such an update would be acquired by the data assembler 130 and the preponderant data domains 250, and the identified parameter set 220 would be updated to include the possibility of the natural disaster. The forecasting model 260 generated thus far may need to be updated to incorporate the impact of the natural disaster as well. The system 110 may be configured to update the forecasting model 260 whenever there may be an update in the preponderant data domains 250.

The modeler 150 may generate a forecasting result 270 corresponding to the forecasting requirement 210. The forecasting result 270 may include the forecasting model 260 relevant for a resolution to the query associated with the forecasting requirement 210. In an example, the forecasting result 270 may be generated as an electronic document in response to the query of the user. In an example, the modeler 150 may provide evidence supporting the forecasting model 260.

In operation, the system 110 may be configured for generation of cognitive forecasts for an organization based on real-time data. In accordance with an example of the present disclosure, the real-time data may be fluctuating constantly. The system 110 may generate the cognitive forecasts for the organization through the processor 120, the data assembler 130, the updater 140, and the monitor 150. As mentioned above, the processor 120 may be coupled to the data assembler 130, the updater 140, and the monitor 150. The data assembler 130 may receive the forecasting requirement 210 from a user of the system 110. The forecasting requirement 210 may be associated with one of a process, an organization, and an industry relevant for operations. The forecasting requirement 210 may include a query sent to the system 110 by the user. In an example, the query may be to generate a new forecast for a particular process, an operation, or an organization. In an example, the query may be to regenerate a previously generated forecast for a process, an operation, or an organization.

The data assembler 130 may receive parameter data from the plurality of data sources. The plurality of data sources may include an external database like an Internet-based database. The plurality of data sources may include an internal database of historical data assimilated for various processes by the organization. Further, the data assembler 130 may identify the parameter set 220 from the parameter data for processing the forecasting requirement 210. The parameter set 220 may be a set of measurable factors which may be associated with the forecasting requirement 210. In an example, the system 110 may identify parameter set for the forecasting requirement 210 using the forecast library mentioned above. In an example, the system 110 may analyze the forecasting requirement 210 and identify critical aspects which may be needed for generating a cognitive forecast for the forecasting requirement 210. Further, the system 110 may associate the critical aspects identified with the parameter data obtained from the plurality of data sources. The system 110 may populate parameter data relevant for the identified critical aspects to form the identified parameter set 220. The system 110 may use the identified parameter set 220 hereon for processing the forecasting requirement 210.

The data assembler 130 may implement the artificial intelligence component 230 to sort the parameter data into a plurality of data domains 240. The artificial intelligence component 230 may be one of a data extractor, a data classifier, a data associator, a data comparer, a relationship extractor, and a dependency parser and the like. In an example, the artificial intelligence component 230 may implement techniques like Natural Language Processing (NLP) and the like for sorting the parameter data into the plurality of data domains 240. For the sake of brevity and technical clarity, a detailed explanation of the techniques like may be presented by way of subsequent FIGS. and is not included here. The system 110 may evaluate each domain from the plurality of data domains 240 for identifying the preponderant data domains 250. In an example, the system 110 may identify at least one domain from the plurality of data domains 240 as being preponderant data domain for the forecasting requirement 210. In an example, the preponderant data domains 250 may be one of the outlier data sets. The system 110 may be configured to use the preponderant data domains 250 hereon, for processing the forecasting requirement 210. In accordance with various examples of the present disclosure, the preponderant data domains 250 may be domains from the plurality of data domains 240, which may have been identified by the system 110 as being having a greater prevalence on the processing of the forecasting requirement 210 (explained in detail by way of subsequent FIGS. along with exemplary embodiments).

As mentioned above, the system 110 may generate cognitive forecasts for real-time fluctuating data. Accordingly, when the updater 140 of the system 110 has identified the parameter set 220 and the preponderant data domains 250 for processing the forecasting requirement 210, the data assembler 130 may detect a modification in at least one of the plurality of data sources from where the parameter data may have been obtained from. Further, the modification detected in the plurality of data sources may lead to a modification in the parameter data. In an example, the modification in the parameter data may lead to a modification in at least one of the plurality of data domains 240. In an example, the modification in the plurality of data domains 240 may lead to identifying a new set of the plurality of data domains 240. In an example, the modification in the plurality of data domains 240 may lead to identifying a new set of values for the plurality of data domains 240 identified before the modification on the parameter data may have been detected. Additionally, the modification in the parameter data may lead to a modification in at least one of the sets from the parameter set 220. In an example, the modification in the parameter set 220 may lead to the identification of new parameter set 220. In an example, the modification in the parameter set 220 may lead to the identification of new values for the parameter set 220 identified before the modification on the parameter data may have been detected. The system 110 may be configured to update the preponderant data domains 250 based on the respective modifications in the parameter set 220 and the plurality of data domains 240. The system 110 may use the updated preponderant data domains 250 hereon for processing the forecasting requirement 210.

The modeler 150 may be configured to obtain the updated preponderant data domains 250 from the updater 140. Further, the modeler 150 may obtain the identified parameter set 220 from the data assembler 130. In an example, the modeler 150 may obtain the updated parameter set 220 from the updater 140. The modeler may establish a forecasting model 260 corresponding to the forecasting requirement 210 associated with the query by performing the cognitive learning operation on a domain from the updated preponderant data domains 250 and the identified parameter set 220. The cognitive learning operation may include deployment of various tools and techniques (explained in detail by way of subsequent FIGS.) The system 110 may use the forecasting model 260 for generating a result for the forecasting requirement 210. Further, as mentioned above, the system 110 may generate cognitive forecasts for real-time fluctuating data. Accordingly, the system 110 may detect a modification in the parameter data after the forecasting model 260 may have been established. The modification in the parameter data may lead to respective modifications in the parameter set 220 and the updated preponderant data domains 250 after they have been deployed by the system 110 for generation of the forecasting model 260. The modeler 150 of the system 110 may be configured so as to update the forecasting model 260 corresponding to the update in the updated preponderant data domains 250. The system 110 may be configured to store all the forecasting models 260 for future use. The modeler 150 may generate a forecasting result 270 corresponding to the forecasting requirement 210. The forecasting result 270 may include the forecasting model 260 relevant for a resolution to the query indicated by the forecasting requirement 210. In an example, the system 110 may deploy multiple forecasting models 260 for generating the forecasting result 270. In an example, the multiple forecasting models 260 may account for a “best-case” scenario, a “worst case” scenario, and a “normal” scenario. In an example, the system 110 may generate a modification in the forecasting result 270 based on the modification in the forecasting model 260. In an example, the system 110 may require permission from the user for generating the modification in the forecasting result 270 based on the modification in the forecasting model 260. In an example, the system 110 may generate the modification in the forecasting result 270 based on the modification in the forecasting model 260 through using a pre-set condition by the user. The pre-set condition may refer to a permission given by the user for updating the forecasting result 270 if the system 110 may detect a specified set of modifications in the forecasting model 260. In an example, the forecasting result 270 may be generated in an electronic format. In an example, the user may be electronically notified regarding a modification in any of the preponderant data domains 250, the parameter set 220, the forecasting model 260, and the forecasting result 270.

FIG. 3 illustrates key areas of a cognitive forecasting model 300, according to an example embodiment of the present disclosure. Any of the components of the system 110 may be used for implementation of the system 300. For the sake of brevity and technical clarity an explanation of the components of the system 110 is not being included here and may be referred to from FIG. 1 and FIG. 2.

In accordance to an example of the present disclosure, the system 300 may include a user 302 (or multiple user 302), a plurality of input channels 304 (also referred to as input channels 304), a plurality of input parameters 306 (also referred to as input parameters 306), a set of convertors 308 (also referred to as convertors 308), a set of artificial intelligence advisors 310 (also referred to as AI advisors 310), and a storage 312. The user 302 may send a forecasting requirement similar to the forecasting requirement 210 to the system 110. The input channels 304, the input parameters 306, the convertors 308, the AI advisors 310, and the storage 312 may be configured to implement the system 300.

The input channels 304 may further an independent component 314, an independent component 316, and a set of historical data 318. The independent component 314, the independent component 316, and the historical data 318 may for the plurality of data sources as mentioned above. In an example, the user may select multiple components like the independent component 314, and the independent component 316 for processing the forecasting requirement 210. In an example, the independent component 314, and the independent component 316 may be the external data sources mentioned above, and the historical data 318 may be the internal data source mentioned above. The system 300 may interact with the independent component 314, the independent component 316, and the historical data 318 to form the parameter data mentioned above.

The input parameters 306 component of the system 300 may receive the parameter data from the external data sources of input channels 304 through an input medium 320, an input medium 324, and an input medium 326. In an example, the input parameters 306 may receive the parameter data from the input channels 304 through multiple input mediums like the input medium 322, input medium 324, and the input medium 326. The input parameters 306 component of the system 300 may receive the parameter data from the internal data sources of input channels 304 through an input medium 328. The system 300 may include an analysis component 326. The analysis component 326 may be configured to form a conglomerate of parameter data received from the input channels 304 and associate the same with forecasting requirement 210 received from the user 302. Further, the analysis component 326 may calculate the requirement of parameter data from more independent components like those mentioned above. In an example, the analysis component 326 may identify the parameter set 220 mentioned above from analysis of the input data received from the input channels 304. In an example, the analysis component 326 may also include the artificial intelligence component 230 for sorting the input data into the plurality of data domains 240 and identifying preponderant data domains 250 therefrom. In an example, the analysis component 326 may require additional input from the input channels 304 based on analysis of received input data and the forecasting requirement 210.

The input parameters 306 component may push the analyzed parameter data to the convertors 308 through an input process 330. In an example, the analyzed data may include the identified parameter set 220 and the preponderant data domains 250. The convertors 308 may convert the parameter set 220 and the preponderant data domains 250 into a format recognized by the system 300 and send the processed parameter set 220 and the preponderant data domains 250 to the AI advisors 310. The AI advisors 310 may include factorizing the independent actual criteria to be considered for processing the forecasting requirement 210. Further, the AI advisors 310 may consider the historical data 318 received from the input channels 304 and the input parameters 306. The AI advisors 310 may generate a recommendation 334 based on criterion deemed most critical for processing the forecasting requirement 210 by the AI advisors 310. In an example, the recommendation 334 may be the forecasting model 260.

As mentioned above, As mentioned above, the system 110 (and system 300 by extension) may generate cognitive forecasts for real-time fluctuating data. Accordingly, when the input channels 304 and the input parameters 306 may detect a change in any of the input received from the independent component 314, the independent component 316, the convertors 308 may receive a communication to pull the recommendation 334 from the AI advisors 310 through a pull process 332. In an example, the pulled recommendation 334 may be sent by the convertors 308 to the analysis component 326 for further analysis. In an example, the analysis component 326 may compare the input that formed that basis for recommendation 334 with the updated input received from the input channels 304. Further, the comparison may lead to the detection of a difference between the input that formed that basis for recommendation 334 with the updated input received from the input channels 304. The input parameters 306 may send the updated input received from the input channels 304 and the comparison undertaken as mentioned above to the convertors 308. The convertors 308 may send the same to the AI advisors 310 through the input process 330. The AI advisors 310 may update the recommendation 334.

In an example, the AI advisors 310 may apply a resolution 336 to the updated input received from the input channels 304 through the analysis component 326 and the convertors 308. The resolution 336 may lead to the generation of an update in the recommendation 334. The recommendation 334 after application of the resolution 336 may be sent to the storage 312. In an example, recommendation 334 may be the forecasting model 260 and the resolution 336 may be the update generated in the forecasting model 260 by the modeler 150 corresponding to the update in the parameter set 220 and the preponderant data domains 250. The storage 312 may store a forecasted value 338 obtained from the recommendation 334 after application of the resolution 336. In an example, the forecasted value 338 may be the forecasting result 270. The storage 312 may store the forecasted value 338 for future use for processing a requirement like the forecasting requirement 210. In an example, the AI advisors 310 may include the cognitive learning operation for generation of the recommendation 334 and the resolution 336.

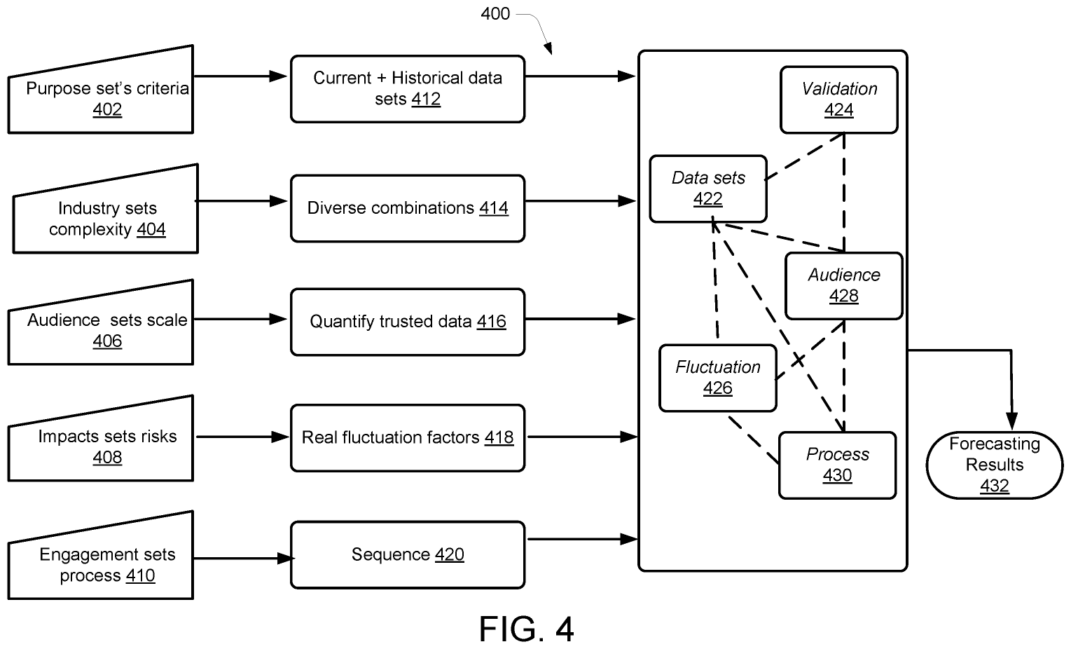

FIG. 4 illustrates a process flowchart 400 for generating the parameter set 220 and a forecast based on the cognitive forecasting model, according to an example embodiment of the present disclosure. Any of the components of the system 110 and the system 300 may be used for implementation of the process flowchart 400 (referred to as process 400). For the sake of brevity and technical clarity an explanation of the components of the system 110 is not being included here and may be referred to from FIG. 1 and FIG. 2.

The process 400 illustrates working of the system 110 for generation of cognitive forecast models in accordance with an exemplary embodiment of the present disclosure. The system 110 or the system 300 may receive a requirement similar to the forecasting requirement 210 and may deploy the process 400 for identification of the parameter set 220.

In an example, the system 110 may analyze the forecasting requirement 210 and may identify various measurable parameters for processing the same. The measurable parameters may be based on the purpose of the forecasting requirement 210, an industry related to the forecasting requirement 210, an audience level for whom the forecasting requirement 210 may be being generated, a risk level associated while processing the forecasting requirement 210, and a sequence of events related to the purpose of the forecasting requirement 210. Accordingly, the process 400 may include a purpose set 402, an industry set 404, an audience set 406, an impact set 408, and an engagement set 410. The process 400 or system 110 may use the purpose set 402, the industry set 404, the audience set 406, the impact set 408, and the engagement set 410 for processing the forecasting requirement 210.

The purpose set 402 may include accessing the forecast library mentioned above and identifying a set of historical data set 412. The historical data set 412 may include a purpose similar to the purpose of the forecasting requirement 210. The historical data set 412 for the forecasting requirement 210 may be identified through associating the purpose of the forecasting requirement 210 with the purpose of the requirement for which the historical data set 412 may have been generated. The historical data set 412 may include the internal data sources of the plurality of data sources mentioned above. In an example, the historical data set 412 may include the forecasting model 260, which may have been constructed for a requirement similar to the forecasting requirement 210. In an example, the purpose set 402 may include acquiring a data set relevant for a current purpose of the forecasting requirement 210. The historical data set 412 may facilitate in the identification of parameter 220 with respect to the purpose of the forecasting requirement 210. For example, the forecasting requirement 210 may relate to the introduction of training courses for human resources in a research cell of a pharmaceutical organization. The system 110 may identify the purpose set 402 of the parameter set 220 based on historical data and current data for training courses required in the pharmaceutical sector. The system 110 would interact with the plurality of data sources and extract relevant information from the same.

The system 110 may analyze the forecasting requirement 210 for identifying relevant industrial sectors for the forecasting requirement 210. For example, the forecasting requirement 210 may broadly relate to the pharmaceutical industry and may specifically relate to training courses for research professionals. The system 110 would interact with the plurality of data sources and extract relevant parameter data pertaining to, for example, the pharmaceutical domain. The system 110 would generate a diverse combination set 414. The diverse combinations set 414 may include various combinations generated by the system 110, which may be related research activities taking place in the pharmaceutical industry and how various courses may be undertaken. The system 110 may identify the industry set 404 of the parameter set 220 based on the diverse combinations set 414.

The system 110 may analyze the forecasting requirement 210 for identifying relevant audience related to the forecasting requirement 210. For example, the forecasting requirement 210 may broadly relate to pharmaceutical industry and may specifically relate to training courses for research professionals. The system 110 would interact with the plurality of data sources and extract relevant parameter data pertaining to for example, the research professionals in general and research professionals in the pharmaceutical industry in particular. The system 110 may generate a dataset 416. The dataset 416 may include a quantification of data across the plurality of data sources regarding audience related to the forecasting requirement 210. In an example, the dataset 416 may include input from the user regarding a number of people, for whom the training programs may be required. In an example, the dataset 416 may include input from the user regarding the qualifications and skills of people for whom the training programs may be required. The system 110 may identify the audience set 406 of the parameter set 220 based on quantity and skillset of professionals for whom, the training courses may be required in the pharmaceutical sector.

The system 110 may analyze the forecasting requirement 210 for identifying relevant impact sectors or risk sets for the forecasting requirement 210. For example, the forecasting requirement 210 may broadly relate to pharmaceutical industry and may specifically relate to training courses for research professionals. The system 110 would interact with the plurality of data sources and extract relevant parameter data pertaining to, for example, the measurable factors, which may tend to fluctuate over time. The system 110 would generate a set of real fluctuation factors 418. The system 110 may identify the impact set 408 of the parameter set 220 based on real fluctuating data for training courses deployed in the pharmaceutical sector. For example, the impact set 408 may include data for any training courses, which have now been rendered obsolete, data for any new training courses, data on any resurfacing training courses and the like. The system 110 may identify the impact set 408 of the parameter set 220 based on real fluctuating data for training courses deployed in the pharmaceutical sector.

The system 110 may analyze the forecasting requirement 210 for identifying relevant engagement process related to resolving the forecasting requirement 210. For example, the forecasting requirement 210 may broadly relate to pharmaceutical industry and may specifically relate to training courses for research professionals. The system 110 would interact with the plurality of data sources and extract relevant parameter data pertaining to, for example, a process, which may need to be followed in order to develop a forecast for the training courses for research professionals in the pharmaceutical sector. The system 110 would generate a sequence 420. The sequence 420 might comprise data on the execution of the purpose laid out by the forecasting requirement 210. The system 110 may identify the engagement set 410 of the parameter set 220 based on a process to be followed for resolving the forecasting requirement 210. For example, execution of training courses for research professionals in the pharmaceutical sector.

For the sake of brevity and technical clarity, the example of the introduction of training courses for research professionals in pharmaceutical sector has been presented herein, however, it should be understood by a person skilled in the art that aforementioned system 110 and the process 400 may be applied across any sector for processing any forecasting requirement.

Further, the purpose set 402, the industry set 404, the audience set 406, impact set 408, and the engagement set 410 may be refactored by the system 110. The system 110 may generate a data set 422, a validation 424, a fluctuation 426, an audience 428, and a process 430 by refactoring the input and results received from the input channels 304, the input parameters 306, the AI advisors 310, the purpose set 402, the industry set 404, the audience set 406, the impact set 408, and the engagement set 410. The system 110 may associate and compare the data set 422, the validation 424, the fluctuation 426, the audience 428, and the process 430 with each other for generating a forecasting result 432. In an example, the forecasting result 432 may be similar to the forecasting result 270.

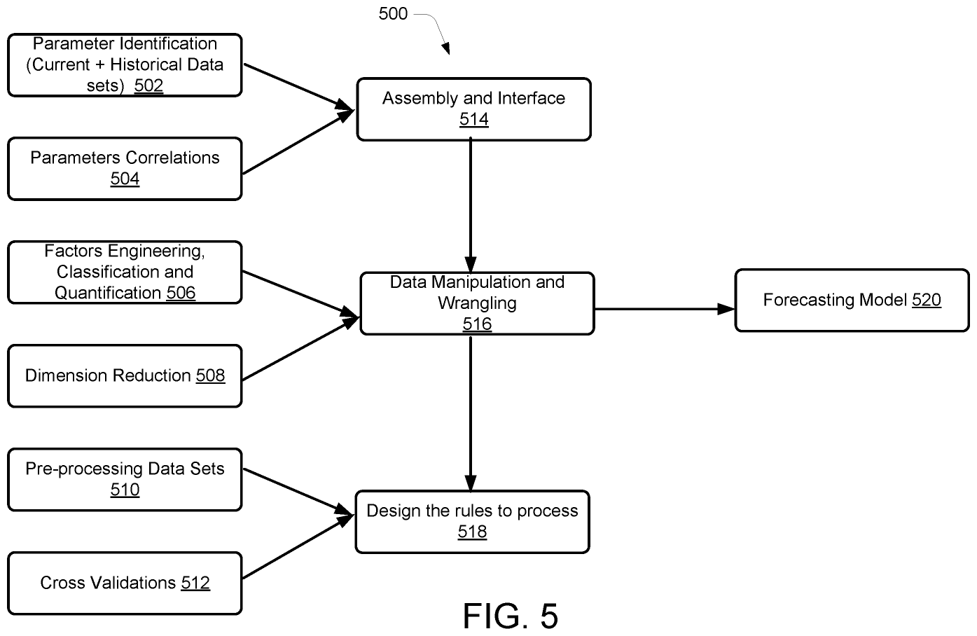

FIG. 5 illustrates a process flowchart 500 (referred to as process 500) of algorithmic details for cognitive forecasting model, according to an example embodiment of the present disclosure. Any of the components of the system 110 may be used for implementation of the process flowchart 500. For the sake of brevity and technical clarity an explanation of the components of the system 110 is not being included here and may be referred to from FIG. 1 and FIG. 2.

As mentioned above the system 110 may refactor the input and results received from the input channels 304, the input parameters 306, the AI advisors 310, the purpose set 402, the industry set 404, the audience set 406, the impact set 408, and the engagement set 410. The refactoring may be accomplished through the process 500. The process 500 may include three stages namely a first stage called an assembly and interface stage 514, a second stage called a data manipulation and wrangling stage 516, and a third stage called a design rules to process stage 518.

The assembly and interface stage 514 may include a parameter identification 502, and a parameters correlation 504. The parameter identification 502 may include deployment of Natural Language Processing (NLP) techniques for terminology extraction to automatically extract relevant terms from a purpose of the forecasting requirement 210 sent to the system 110 by the user. In an example, the terminology extraction may select the parameters from training data using NLP. Additionally, the system 110 may map the labeled & un-labeled variables and prepare a schema. The system 110 may assign weight to terms, which have been extracted through terminology extraction. Further, the system 110 may assign a high weight to some of the terms extracted from the terminology extraction. The system 110 may assign a low weight to some of the terms extracted from terminology extraction. The system 110 may analyze the low weight data and find reasons from the plurality of data sources for the data being assigned a low weight. This may outline a set of real fluctuation scenarios, which may lead to a low weight output for a particular entry. The system 110 may be configured to store all the high weight terms as well as the low weight terms for future reference. The system 110 may also be configured to store reasons for terms being assigned as low weight for future reference, thereby making the system 110 a self-learning system requiring minimal human intervention.

The parameters correlation 504 may include deployment of an Apriori Algorithm. The Apriori Algorithm may determine association rules, which may highlight a general pattern & a trend in the input data. In an example, the patterns may be the presence of a third component while comparing a data set for a first component and a second component. For example, an employee of an organization, who has attempted to take a training course may have reached a certain level of training. The parameters correlation 504 may identify a minimum value and a maximum value, thereby defining a range and may include all data lying in the range as relevant data for processing the forecasting requirement 210. For example, the forecasting requirement 210 may be an investment into a promotional training program for employees of an organization. The parameter identification 502 and the parameters correlation 504 may decipher that employees with a minimum 30% of training and maximum 100% of training might only be considered for a specific promotional training program. In an example, the range for parameter data to be included in the parameter set 220 may be defined by the user. In an example, the range for parameter data to be included in the parameter set 220 may be presented by the system 110 to the user and may be implemented after acquiring permission from the user.

The data manipulation and wrangling stage 516 may include a factor engineering component 506, and a dimension reduction 508. The factor engineering component 506 may be implemented through a Classification and Regression Tree (CART) method. The CART method may include rules for splitting data that may generate the best decision for the purpose of the forecasting requirement 210, based on the value of one parameter. For example, mean percentage completion of the training course undertaken by the employees of an organization as mentioned above. The CART method may consider the minimum (0%) and the maximum (100%) value of a parameter and then divide the range equally in 3. The CART method may include different combinations of the range. For example, a first combination may be a low value and a medium value, a second combination may be the medium value and a high value, and a third combination may be the high value and the low value. The CART method may calculate different means value to find the credibility of the split from the data.

The dimension reduction 508 may be implemented through Principal Component Analysis (PCA). The PCA may be used to simplify the input data received through the input channel 304. The PCA may consider real fluctuations. For example, real fluctuations like an exit case, a resource with other engagements, and similar details, which may might not be available directly from any database, but would need to be arranged from other sources. The PCA may consider the real fluctuations and may arrange data as well from other sources while processing the data. The PCA may increase the accuracy of the forecasting.

The design rules to process stage 518 may include a pre-processing of data sets stage 510 and a cross-validations stage 512. The pre-processing of data sets stage 510 may be implemented through the application of logic by the system 110 (explained further in detail by way of FIG. 6 and FIG. 7 using exemplary embodiments). The cross validations stage 512 may be implemented through a logistic regression technique. The input values may be combined linearly using weights to predict an output value. The regression output value may be modeled in binary values (0 or 1). For example, the probability of getting eligible skilled resources may change based on the percentage of training course completed by employees of an organization (from the example mentioned above).

The system 110 may assign weight to terms, which have been extracted through terminology extraction. Further, the system 110 may assign a high weight to some of the terms extracted from the terminology extraction. The system 110 may assign a low weight to some of the terms extracted from terminology extraction. The system 110 may be configured to reiterate the three stages namely the assembly and interface stage 514, the data manipulation and wrangling stage 516, and the design rules to process stage 518 and share the results with the user. In an example, the user may decide if the low weight data may be critical to the processing of the forecasting requirement 210.

The system 110 may implement the three stages namely the assembly and interface stage 514, the data manipulation and wrangling stage 516, and the design rules to process stage 518 for generation of a forecasting model 520. The forecasting model 520 may be similar to the forecasting model 260.

FIG. 6 illustrates a process flowchart 600 for a use case for cognitive forecasting model, according to an example embodiment of the present disclosure. Any of the components of the system 110 may be used for implementation of the process flowchart 600. The use case illustrated by FIG. 6 may be the forecasting requirement 210 related to fulfillment of recruitment demands for a particular skill from within an organization. For example, the purpose of the forecasting requirement 210 may be the fulfillment of recruitment demands for professionals with minimum 5 years' experience in artificial intelligence domain (AI) internally and find eligible employees within an organization named Accenture®. Such identification of purpose may establish the purpose set 402. The solution to the purpose may be that the system 110 may identify the most eligible employees who may be considered for project open demands, based on courses/training that may be taken, which shows their interest towards the specific skills other their than primary/secondary skill. The system 110 may offer the most eligible internal supply, which may be a low-cost liability for the company as compared with external sourcing. Additionally, a lead time to get resources onboard or fulfill the demands may be less compared to external recruitment. Further, a less risk component may be associated with onboarding internal resources as compared to cases from external sourcing.

As mentioned above, system 110 may use the purpose set 402, the industry set 404, the audience set 406, the impact set 408, and the engagement set 410 for processing the forecasting requirement 210. The process 600 may perform an identification 602. The identification 602 may include identifying an industry associated with the forecasting requirement 210. For example, the identification 602 may identify a learning industry 604 as the industry associated with the forecasting requirement 210, thereby establishing the industry set 404. The audience set 406 may be identified for process 600 through an identification 606. The audience set 406 may be an information governance lead person of an organization, a managing director, a project manager, and a senior manager.

The process 600 may implement the assembly and interface stage 514 through a parameter identification 608. The parameter identification 608 may include identifying the right set of criteria's and co-relations from learning data sets for generating an identified parameter set 610. Few exemplary parameters identified may include a percentage completion of a training course (for e.g. 60%, of the course, is completed), a course completion date, a course duration undertaken, a playability factor, a training type, a training course registration date, number of courses completed by an employee for a particular skill, a survey result, a career level and the like. The process 600 may deploy a learning data 612. The learning data 612 may comprise, for example, records of five employees meeting the criterion. In an example, the learning data 612 may include the preponderant data domains 250.

The process 600 may associate the identified parameter set 610 with the learning data 612 and implement the cognitive learning operation for establishing a filter data 622. The cognitive learning operation may include a condition 614, a condition 616, a condition 618, and a condition 620. The condition 614 may include analyzing percentage completion of the training course, and the course completion date for all five records retrieved from the learning data 612. For example, the process 600 may only consider records with the course completion date being within 1 year from data of analysis. The process 600 may only consider records with the percentage completion of the training course being above a mean percentage of completion of that course. The user may define the mean percentage of completion value for each forecasting requirement 210. For example, a total percentage of completion of the course may be “100”. As mentioned above, the system 110 may generate the high, the low, and the medium values and prepare combinations thereof as part of the factor engineering component 506. For the illustrated example, when an employee completes the course the percentage completion of the training course is 100%. The range may now be defined as 0% to 100%. The process 600 would divide the range equally, thereby marking an interval of 0%-33% as “low”, an interval of 34%-66% as “medium” interval, and an interval of “67%-100% as “high interval”. The process 600 may now prepare different combinations of the range and generate different means value to find the credibility of the split from the data. In an example, the user may define the condition 614 as per organizational requirements.

The condition 616 may include analyzing the course duration undertaken, and the playability factor of the course for all five records retrieved from the learning data 612. For example, the process 600 may only consider records with the course duration undertaken by an employee being greater than a value of the total course duration divided by the mean percentage of completion value for that course. The process 600 may only consider records with the playability factor between a specified range. For example, the playability factor may be between a value that may be half the number of hours of course duration and a value that may be double the number of hours of course duration. In an example, the user may define the condition 616 as per organizational requirements.

The condition 618 may include analyzing the training type for all five records retrieved from the learning data 612. For example, the training may be undertaken as an online mode and or as a classroom mode. The process 600 may only assign a value “1” to all records, which mention the online training mode and a value “2” to all records, which mentioned the classroom training mode. In an example, the user may define the condition 618 as per organizational requirements.

The condition 620 may include analyzing the survey result for all five records retrieved from the learning data 612. For example, the process 600 may only consider records with a particular satisfaction level from senior management. In an example, the user may define the condition 620 as per organizational requirements.

The results of the condition 614, the condition 616, the condition 618, and the condition 620 may lead to the generation of the filtered data 622. The filtered data 622 may include the forecasting model 260. The filtered data 622 may be processed by the system 110 for generation of the outcome 624. In an example, the outcome 624 may be a number of internal eligible resources for fulfillment of the forecasting requirement 210. The fluctuating data in this example may be an employee who might have resigned, distribution location and prior commitment of the employee, and the like. The human resource departments of an organization possess such fluctuating data and same may be arranged for the purpose of the process 600.

FIG. 7 illustrates a process flowchart 700 for a use case for cognitive forecasting model, according to an example embodiment of the present disclosure. Any of the components of the system 110 may be used for implementation of the process flowchart 700. The use case illustrated by FIG. 7 may be the forecasting requirement 210 related to fulfillment of forecasting of the sale of an apartment building in different countries so that investors may invest only in the countries and plan for the construction of housing which may provide high returns. The solution to the purpose may be that the system 110 may identify the forecasting model may find the most sequential high profits countries or regions which may be considered for the construction of housing and sale of apartments based on the different factors and demand. The system 110 may offer the most highly demanding countries or regions, which may give the right vision to investors. Further, the system 110 may measure and assist the investors to take right decisions for maintenance of constructed apartments. Additionally, the system 110 may minimize risk associated with the overall process of sale for setting up the infrastructure.

As mentioned above, system 110 may use the purpose set 402, the industry set 404, the audience set 406, the impact set 408, and the engagement set 410 for processing the forecasting requirement 210. The process 700 may perform an identification 702. The identification 607 may include identifying an industry associated with the forecasting requirement 210. For example, the identification 702 may identify a technology industry 704 as the industry associated with the forecasting requirement 210, thereby establishing the industry set 404. The audience set 406 may be identified for the process 700 through an identification 706. The audience set 406 may be a group of investors.

The process 700 may implement the assembly and interface stage 514 through a parameter identification 708. The parameter identification 708 may include identifying the right set of criteria's and co-relations from country-wise data sets for generating an identified parameter set 710. Few exemplary parameters identified may include a political stability factor, a gross domestic product (GDP) factor, an innovation index factor, a population density factor, an environment index factor, a social index factor, a human development index factor and the like. The process 700 may deploy a country data 712. The country data 712 may comprise, for example, records of ten countries meeting the criterion. In an example, the learning data 712 may include the preponderant data domains 250.

The process 700 may associate the identified parameter set 710 with the country data 712 and implement the cognitive learning operation for establishing a filter data 722. The cognitive learning operation may include a condition 714, a condition 716, a condition 718, and a condition 720.

The condition 714 may include analyzing the political stability factor and the environment index factor for all ten records retrieved from the country data 712. For example, the process 700 may only consider records with the political stability factor above a specified point. The user may define the specified point as per organizational requirements. The process 700 may only consider records with the environment index factor being greater than a mean marking value of the environment index factor. In an example, the user may define the mean marking value for the environment index factor for each forecasting requirement 210. In an example, the user may define the condition 714 as per organizational requirements.

The condition 716 may include analyzing the population density factor and the GDP factor for all ten records retrieved from the country data 712. For example, the process 700 may only consider records with the population density factor being greater than the mean marking value of the population density factor. In an example, the user may define the mean marking value for the population density factor for each forecasting requirement 210. The process 700 may only consider records with the GDP factor being greater than a mean marking value of the GDP factor. In an example, the user may define the mean marking value for the GDP factor for each forecasting requirement 210. In an example, the user may define the condition 716 as per organizational requirements.

The condition 718 may include analyzing the social & human development index factor for all ten records retrieved from the country data 712. For example, the process 700 may only consider records with the social & human development index factor being greater than a mean marking value of the social & human development index factor. In an example, the user may define the mean marking value for the social & human development index factor for each forecasting requirement 210. In an example, the user may define the condition 718 as per organizational requirements.

The condition 720 may include analyzing the innovation index factor for all ten records retrieved from the country data 712. For example, the process 700 may only consider records with the innovation index factor being greater than a mean marking value of the innovation index factor. In an example, the user may define the mean marking value for the innovation index factor for each forecasting requirement 210. In an example, the user may define the condition 720 as per organizational requirements. The fluctuating data in this example may be a natural climatic disaster or government stability, which may happen in a region in frequency once in 5 or 10 years. The weather departments may have the data for the climatic disaster and governments have the data of the election, which may arranged for the purpose of the process 700.

Accordingly, for each factor mentioned above, a maximum ranking may be “1”. As mentioned above, the system 110 may generate the high, the low, and the medium values and prepare combinations thereof as part of the factor engineering component 506. For the illustrated example, the ranking for any factor or index may be 1. The range may now be defined as 0 to 1. The process 700 would divide the range equally, thereby marking an interval of 0%-0. 3% as “low”, an interval of 0.3%-0.6% as “medium” interval, and an interval of “0.6%-1.0% as “high interval”. The process 700 may now prepare different combinations of the range and generate different means value to find the credibility of the split from the data.

The results of the condition 714, the condition 716, the condition 718, and the condition 720 may lead to the generation of the filtered data 722. The filtered data 722 may include the forecasting model 260. The filtered data 722 may be processed by the system 110 for generation of the outcome 724. In an example, the outcome 724 may be a sequence of the high profitable region for sales generated by the system 110 for the fulfillment of the forecasting requirement 210.

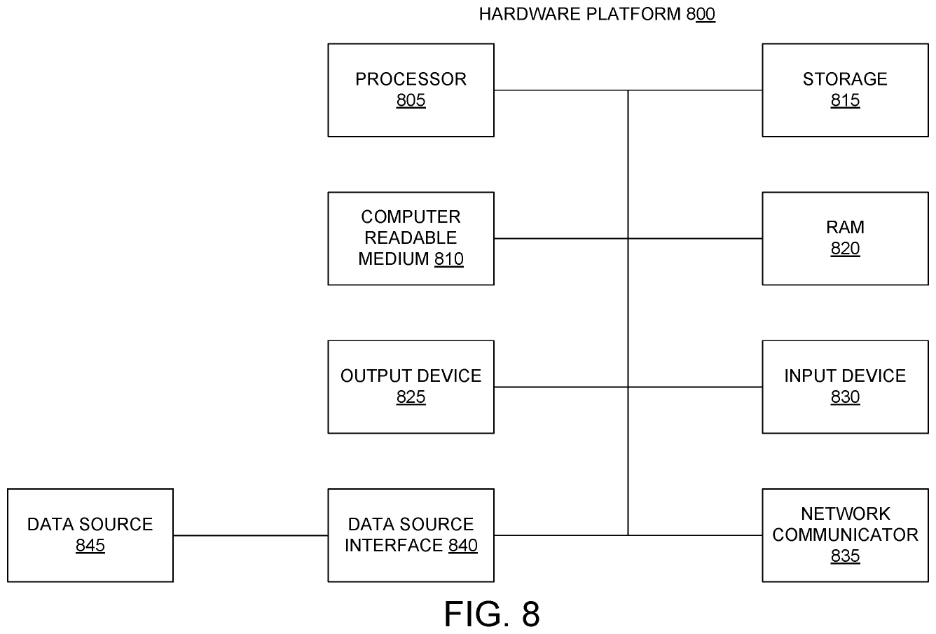

FIG. 8 illustrates a hardware platform 800 for implementation of the system 110, according to an example embodiment of the present disclosure. Particularly, computing machines such as but not limited to internal/external server clusters, quantum computers, desktops, laptops, smartphones, tablets and wearables which may be used to execute the system 110 or may have the structure of the hardware platform 1600. The hardware platform 1600 may include additional components not shown and that some of the components described may be removed and/or modified. In another example, a computer system with multiple GPUs can sit on external-cloud platforms including Amazon Web Services, or internal corporate cloud computing clusters, or organizational computing resources, etc.

Over FIG. 8, the hardware platform 800 may be a computer system 800 that may be used with the examples described herein. The computer system 800 may represent a computational platform that includes components that may be in a server or another computer system. The computer system 800 may execute, by a processor (e.g., a single or multiple processors) or other hardware processing circuit, the methods, functions and other processes described herein. These methods, functions and other processes may be embodied as machine-readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory). The computer system 800 may include a processor 805 that executes software instructions or code stored on a non-transitory computer-readable storage medium 810 to perform methods of the present disclosure. The software code includes, for example, instructions to gather data and documents and analyze documents. In an example, the data assembler 130, the updater 140 and the modeler 150 may be software codes or components performing these steps.

The instructions on the computer-readable storage medium 810 are read and stored the instructions in storage 815 or in random access memory (RAM) 820. The storage 815 provides a large space for keeping static data where at least some instructions could be stored for later execution. The stored instructions may be further compiled to generate other representations of the instructions and dynamically stored in the RAM 820. The processor 805 reads instructions from the RAM 820 and performs actions as instructed.

The computer system 800 further includes an output device 825 to provide at least some of the results of the execution as output including, but not limited to, visual information to users, such as external agents. The output device can include a display on computing devices and virtual reality glasses. For example, the display can be a mobile phone screen or a laptop screen. GUIs and/or text are presented as an output on the display screen. The computer system 800 further includes input device 830 to provide a user or another device with mechanisms for entering data and/or otherwise interact with the computer system 800. The input device may include, for example, a keyboard, a keypad, a mouse, or a touchscreen. In an example, the output of the updater 140 150 is displayed on the output device 825. Each of these output devices 825 and input devices 830 could be joined by one or more additional peripherals. In an example, the output device 825 may be used to display the results of the forecasting result 270.

A network communicator 835 may be provided to connect the computer system 800 to a network and in turn to other devices connected to the network including other clients, servers, data stores, and interfaces, for instance. A network communicator 835 may include, for example, a network adapter such as a LAN adapter or a wireless adapter. The computer system 800 includes a data source interface 840 to access data source 845. A data source is an information resource. As an example, a database of exceptions and rules may be a data source. Moreover, knowledge repositories and curated data may be other examples of data sources. In an example, the plurality of data domains 240 240 may be the data source 845.

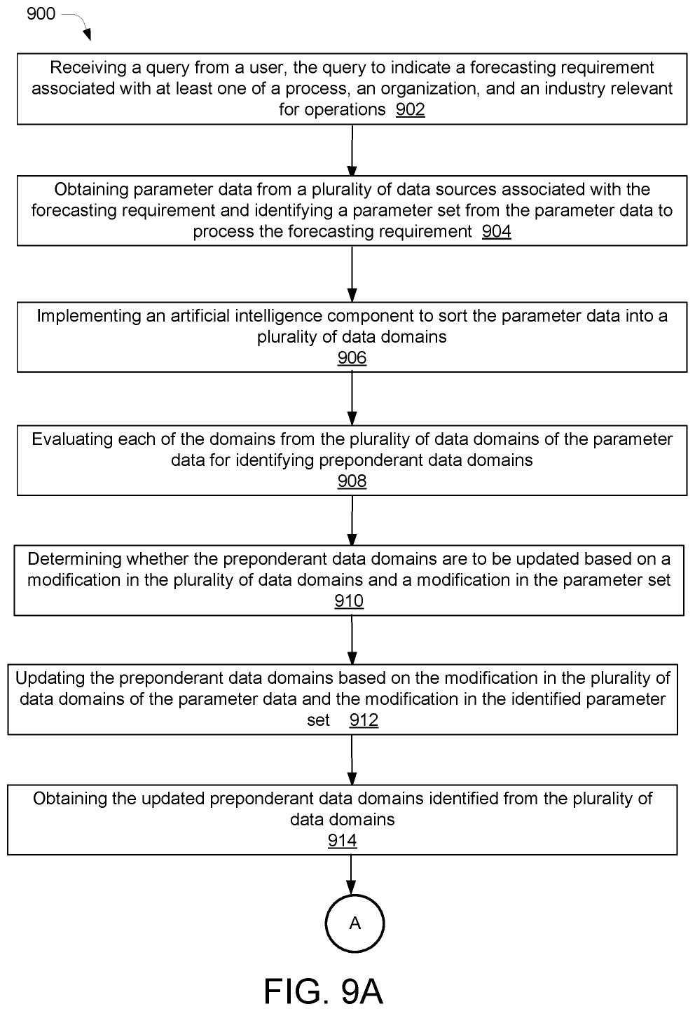

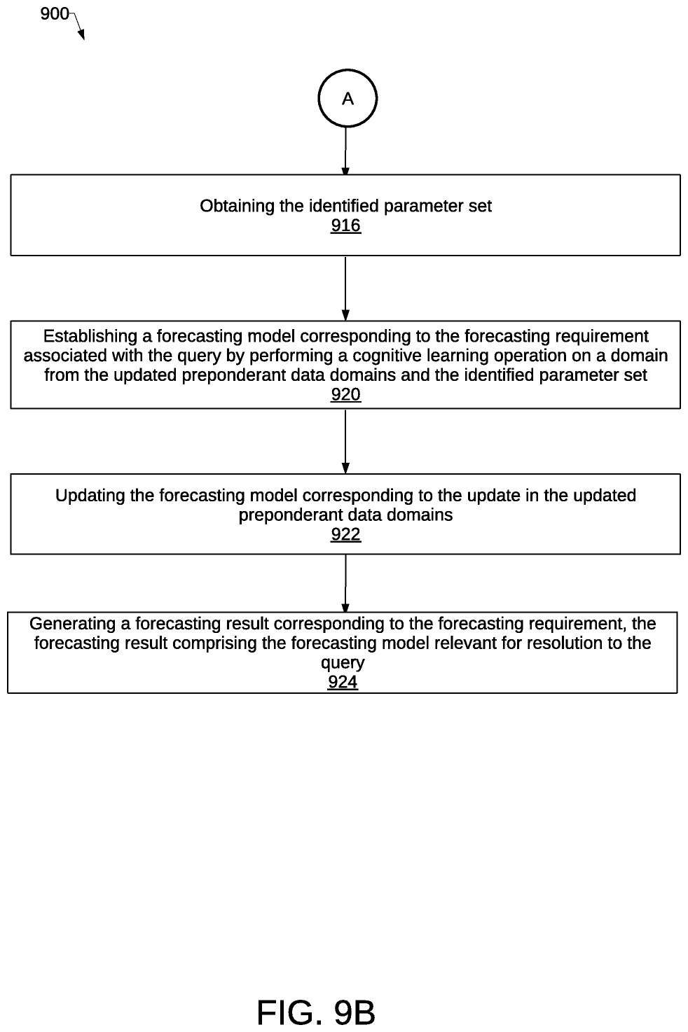

FIGS. 9A and 9B illustrate a method 900 for cognitive forecasting model 260 according to an example embodiment of the present disclosure.

It should be understood that method steps are shown here for reference only and other combination of the steps may be possible. Further, the method 900 may contain some steps in addition to the steps shown in FIG. 9. For the sake of brevity, construction and operational features of the system 110 which are explained in detail in the description of FIG. 1, FIG. 2, FIG. 3, FIG. 4, FIG. 5, FIG. 6, FIG. 7, FIG. 8, and FIG. 9 are not explained in detail in the description of FIG. 9. The method 900 may be performed by a component of the system 110, such as the processor 120, the data assembler 130, the updater 140 and the modeler 150.

At block 902, a query may be received from a user. The query may indicate a forecasting requirement 210 associated with at least one of a process, an organization, and an industry relevant for operations.

At block 904, parameter data may be obtained from a plurality of data sources associated with the forecasting requirement 210 and identifying a parameter set 220 to process the forecasting requirement 210.

At block 906, an artificial intelligence component may be implemented to sort the parameter data into a plurality of data domains 240.

At block 908, each of the domains from the plurality of data domains 240 of the parameter data may be evaluated for identifying preponderant data domains 250.

At block 910, a determination may be initiated whether the preponderant data domains 250 may to be updated based on a modification in the plurality of data domains 240 and a modification in the parameter set 220.

At block 912, the preponderant data domains 250 may be updated based on the modification in the plurality of data domains 240 of the parameter data and the modification in the identified parameter set 220.

At block 914, the updated preponderant data domains 250 identified from the plurality of data domains 240 may be obtained.

At block 916, the identified parameter set 220 may be obtained.

At block 918, a forecasting model 260 may be established corresponding to the forecasting requirement 210 associated with the query by performing a cognitive learning operation on a domain from the updated preponderant data domains 250 and the identified parameter set 220.

At block 920, the forecasting model 260 may be updated corresponding to the update in the updated preponderant data domains 250.

At bock 922, a forecasting result may be generated corresponding to the forecasting requirement 210, the forecasting result comprising the forecasting model 260 relevant for a resolution to the query.

In an example, the method 900 may be practiced using a non-transitory computer-readable medium. In an example, the method 900 may be a computer-implemented method.

The present disclosure provides for continuous collection and analysis of information and may also provide relevant recommendations on demand, allowing users to shift from event-based to continuous sourcing. The present disclosure may substantially reduce the time required in responding to market opportunities. The present disclosure for cognitive forecasting model 260 may eliminate substantial time spent on labor-intensive analysis, providing a huge boost in agility, responsiveness, and productivity.

What has been described and illustrated herein are examples of the present disclosure. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

I/We claim:

1. A system comprising:
a processor;
a data assembler coupled to the processor, the data assembler to:
receive a query from a user, the query to indicate a forecasting requirement associated with at least one of a process, an organization, and an industry relevant for operations;
obtain parameter data from a plurality of data sources associated with the forecasting requirement and identify a parameter set from the parameter data to process the forecasting requirement;
implement an artificial intelligence component to sort the parameter data into a plurality of data domains; and
evaluate each domain from the plurality of data domains of the parameter data to identify preponderant data domains;
an updater coupled to the processor, the updater to:
determine whether the preponderant data domains are to be updated based on a modification in the plurality of data domains and a modification in the identified parameter set; and
update the preponderant data domains based on the modification in the plurality of data domains and the modification in the identified parameter set; and
a modeler coupled to the processor, the modeler to:
obtain the updated preponderant data domains identified from the plurality of data domains;
obtain the identified parameter set;
establish a forecasting model corresponding to the forecasting requirement associated with the query by performing a cognitive learning operation on a domain from the updated preponderant data domains and the identified parameter set;
update the forecasting model corresponding to the update in the updated preponderant data domains; and
generate a forecasting result corresponding to the forecasting requirement, the forecasting result comprising the forecasting model relevant for resolution to the query.

2. The system as claimed in claim 1, wherein the forecasting result is generated as an electronic document in response to the query of the user.

3. The system as claimed in claim 1, wherein the updater is to further electronically notify the user when there is a change in the preponderant data domains due to the modification in the plurality of data domains and the modification in the identified parameter set.

4. The system as claimed in claim 1, wherein the modeler is to further provide evidence supporting the forecasting model.

5. The system as claimed in claim 1, wherein the data assembler is to further establish a forecast library, by associating the preponderant data domains and the identified parameter set with the forecasting requirement.

6. The system as claimed in claim 5, wherein the modeler is to further analyze the forecast library for validation of the forecasting model.

7. The system as claimed in claim 1, wherein the data assembler is to further update the parameter data simultaneously as the parameter data is acquired by the plurality of data sources.

8. A method comprising:
receiving, by a processor, a query from a user, the query to indicate a forecasting requirement associated with at least one of a process, an organization, and an industry relevant for operations;
obtaining, by the processor, parameter data from a plurality of data sources associated with the forecasting requirement and identifying a parameter set from the parameter data to process the forecasting requirement;
implementing, by the processor, an artificial intelligence component to sort the parameter data into a plurality of data domains;
evaluating, by the processor, each of the domains from the plurality of data domains of the parameter data for identifying preponderant data domains;
determining, by the processor, whether the preponderant data domains are to be updated based on a modification in the plurality of data domains and a modification in the identified parameter set;
updating, by the processor, the preponderant data domains based on the modification in the plurality of data domains of the parameter data and the modification in the identified parameter set;
obtaining, by the processor, the updated preponderant data domains identified from the plurality of data domains;
obtaining, by the processor, the identified parameter set;
establishing, by the processor, a forecasting model corresponding to the forecasting requirement associated with the query by performing a cognitive learning operation on a domain from the updated preponderant data domains and the identified parameter set;
updating, by the processor, the forecasting model corresponding to the update in the updated preponderant data domains; and
generating, by the processor, a forecasting result corresponding to the forecasting requirement, the forecasting result comprising the forecasting model relevant for resolution to the query.

9. The method as claimed in claim 8, wherein the method further comprises generating the forecasting result, by the processor, as an electronic document in response to the query of the user.

10. The method as claimed in claim 8, wherein the method further comprises electronically notifying, by the processor, the user when there is a change in the preponderant data domains due to the modification in the plurality of data domains of the parameter data and the modification in the parameter set identified for the forecasting requirement.

11. The method as claimed in claim 8, wherein the method further comprises providing, by the processor, an evidence supporting the forecasting model.

12. The method as claimed in claim 8, wherein the method further comprises establishing, by the processor a forecast library, by associating the preponderant data domains and the identified parameter set with the forecasting requirement.

13. The method as claimed in claim 12, wherein the method further comprises analyzing, by the processor, the forecast library for validation of the forecasting model.

14. The method as claimed in claim 8, wherein the method further comprises obtaining, by the processor, the parameter data simultaneously as the parameter data is acquired by the plurality of data sources.

15. A non-transitory computer readable medium including machine readable instructions that are executable by a processor to:
receive a query from a user, the query to indicate a forecasting requirement associated with at least one of a process, an organization, and an industry relevant for operations;
obtain parameter data from a plurality of data sources associated with the forecasting requirement and identifying a parameter set from the parameter data to process the forecasting requirement;
implement an artificial intelligence component to sort the parameter data into a plurality of data domains;
evaluate each of the domains from the plurality of data domains of the parameter data for identifying preponderant data domains;
determine whether the preponderant data domains are to be updated based on a modification in the plurality of data domains and a modification in the parameter set;
update the preponderant data domains based on the modification in the plurality of data domains of the parameter data and the modification in the identified parameter set;
obtain the updated preponderant data domains identified from the plurality of data domains;
obtain the identified parameter set;
establish a forecasting model corresponding to the forecasting requirement associated with the query by performing a cognitive learning operation on a domain from the updated preponderant data domains and the identified parameter set;
update the forecasting model corresponding to the update in the updated preponderant data domains; and
generate a forecasting result corresponding to the forecasting requirement, the forecasting result comprising the forecasting model relevant for resolution to the query.

16. The non-transitory computer-readable medium of claim 15, wherein the processor is to generate the forecasting result as an electronic document in response to the query of the user.

17. The non-transitory computer-readable medium of claim 15, wherein the processor is to electronically notify the user when there is a change in the preponderant data domains due to the modification in the plurality of data domains of the parameter data and the modification in the parameter set identified for the forecasting requirement.

18. The non-transitory computer-readable medium of claim 15, wherein the processor is to provide evidence supporting the forecasting model.

19. The non-transitory computer-readable medium of claim 15, wherein the processor is to establish a forecast library, by associating the preponderant data domains and the identified parameter set with the forecasting requirement.

20. The non-transitory computer-readable medium of claim 15, wherein the processor is to obtain the parameter data simultaneously as the parameter data is acquired by the plurality of data sources.
